(19) United States
(12) Patent Application Publication
(10) Pub. No.: US 2010/0012624 A1
(43) Pub. Date: Jan. 21, 2010

(54) High-Voltage Disconnecting Circuit Breaker And Method Of Operating The Same

(76) Inventors: Ulf Akesson, Ludvika (SE); Per L. Holgersson, Ludvika (SE); Magnus N. Olofsson, Kristinehamn (SE); Leif Hoglund, Skedvi (SE)

Correspondence Address: ST. ONGE STEWARD JOHNSTON & REENS, LLC, 986 BEDFORD STREET, STAMFORD, CT, 06905-5619, US

(21) Appl. No.: 12/494,017

(22) Filed: Jun. 29, 2009

Related U.S. Application Data
(63) Continuation of application No. PCT/EP2007/064629, filed on Dec. 28, 2007.

(30) Foreign Application Priority Data
Dec. 29, 2006 (EP) 06445079.4

(51) Int. Cl. H01H 33/34

(52) U.S. Cl. 218/154

(57) ABSTRACT

A high-voltage disconnecting circuit breaker includes a first and a second contact, a mechanism provided for moving the contacts to a first mutual distance, and a mechanism provided for quenching any arc appearing between the contacts during the movement to thereby provide the functionality of a high-voltage circuit breaker, wherein the mechanism provided for moving is further provided for moving the contacts to a second mutual distance larger than the first mutual distance after quenching of any arc to thereby provide the voltage withstand functionality of a high-voltage disconnector.

### CROSS-REFERENCE TO RELATED APPLICATIONS

The present application is a continuation of pending International patent application PCT/EP2007/064629 filed on Dec. 28, 2007 which designates the United States and claims priority from European patent application 06445079.4 filed on Dec. 29, 2006, the content of which is incorporated herein by reference.

### FIELD OF THE INVENTION

The present invention generally relates to a high-voltage disconnecting circuit breaker and to a method of operating such a circuit breaker, which in a fault situation is arranged to disconnect an electrical apparatus from a high-voltage network at each terminal.

### BACKGROUND OF THE INVENTION

Electrical power transmission networks are protected and controlled by high-voltage circuit breakers. Current interruption in a high-voltage circuit breaker is obtained by separating two contacts in a medium, such as sulfur hexafluoride (SF₆), having excellent dielectric and arc quenching properties. After contact separation, current is carried through an arc and is interrupted when this arc is cooled by a gas blast of sufficient intensity.

Typically, a high-voltage air-break disconnector is provided at one or each side of the high-voltage circuit breaker in order to provide electrical isolation according to specified requirements related to repair or maintenance on transmission lines and station equipment. The disconnectors are a major contributor to personnel safety.

However, high-voltage air-break disconnectors are exposed to the atmospheric environment and are thus exposed to corrosion and wear-and-tear. The long term reliability is not too high and the installations require considerable maintenance.

Further, the provision of separate air-break disconnectors adds complexity and costs to the high-voltage circuit breaker installations. Further, they take up a great deal of space. It would be desirable to obtain less complex and costly equipment that would provide the circuit breaking and electrical isolation functionality.

### SUMMARY OF THE INVENTION

In principle, a high-voltage disconnecting circuit breaker can be achieved by proper use of grounding switches and over-dimensioning the circuit breaker, that is, to use a circuit breaker having a higher rated voltage than would be necessary for the current breaking operation, to thereby avoid the drawbacks of the air-break disconnectors.

However, a problem of such approach is that the current breaking operation of such over-dimensioned circuit breaker may not be optimized for the lower voltage as there are many parameters that put restrictions on the circuit breaking operation, in terms of e.g. the speed of removal of the contacts from one another, the distance between the contacts, the injection of quenching gas, etc. and as a result the operation will not be optimized. As a result for instance a more expensive circuit breaker with a higher current interrupting capability must be used.

Further, the operation will be deteriorated in a circuit breaker with worn contacts, since this will affect the circuit breaking capability and the dielectric strength considerably.

An object of the present invention is to provide a high-voltage circuit breaker with an improved dielectric strength when the circuit breaker is in a disconnecting state, so that the high-voltage air-break disconnectors can be dispensed with, while having an optimized current breaking operation.

A further object of the invention is to provide such a high-voltage circuit breaker, which is robust, accurate, uncomplicated, space-saving, and inexpensive, and which has an optimum performance and which fulfills existing safety requirements.

A yet further object of the invention is to provide a method of operating a high-voltage circuit breaker which fulfills the above objects.

The above objects are attained by high-voltage disconnecting circuit breakers and methods as claimed in the appended patent claims.

According to a first aspect of the invention there is provided a high-voltage disconnecting circuit breaker, that is, a combined high-voltage disconnector and high-voltage circuit breaker, comprising a first and a second contact; means provided for moving the contacts to a first mutual distance; and means provided for quenching any arc appearing between the contacts during the movement to thereby provide the functionality of a high-voltage circuit breaker. The means provided for moving is further provided for moving the contacts to a second mutual distance larger than the first mutual distance after quenching of any arc to thereby provide the voltage withstand dielectric strength functionality of a high-voltage disconnector.

The high-voltage disconnecting circuit breaker is preferably optimized so that its high-voltage circuit breaking functionality is optimized and rated for the occurring voltages.

The high-voltage disconnecting circuit breaker according to the invention allows for an increased distance between the two contacts beyond the distance required for interrupting the current and that this increased distance can be used for obtaining increased dielectric strength necessary to provide the disconnecting functionality while still the circuit breaking performance is not affected, that is, the circuit breaking functionality is identical to that of a standard circuit breaker rated for the voltage occurring over the circuit breaker during operation.

According to a second aspect of the invention there is provided a method of operating a circuit breaker comprising a first and a second contact. According to the method the contacts are moved to a first mutual distance and any arc appearing between the contacts is quenched to thereby provide the functionality of a high-voltage circuit breaker. After quenching of any arc, the contacts are moved to a second mutual distance larger than the first mutual distance to thereby provide the functionality of a high-voltage disconnector.

Thus, a method of operating a circuit breaker is provided, wherein increased dielectric strength is obtained by an increased contact stroke, and thereby separate high-voltage air-break disconnectors can be dispensed with.

Further characteristics of the invention and advantages thereof, will be evident from the following detailed description of preferred embodiments of the present invention given hereinafter and the accompanying FIGS. 1-3, which are given by way of illustration only and are thus not limitative of the present invention.

### BRIEF DESCRIPTION OF THE DRAWINGS

FIG. 1 is an overview of a high-voltage circuit breaker according to an embodiment of the invention.

FIGS. 2a-e show the contacts of the high-voltage disconnecting circuit breaker of FIG. 1 during different modes of operation.

FIG. 3 is a diagram showing the axial position of a contact in the high-voltage disconnecting circuit breaker of FIG. 1 during the different modes of operation.

### DETAILED DESCRIPTION OF THE INVENTION

In the following a detailed description of preferred embodiments of the present invention will be given. In this description, the term high voltage will be used for voltages of 1 kV and higher. It shall, however, be noted that the present invention is primarily intended for high-voltage circuit breakers with a voltage rating of 72.5 kV and above.

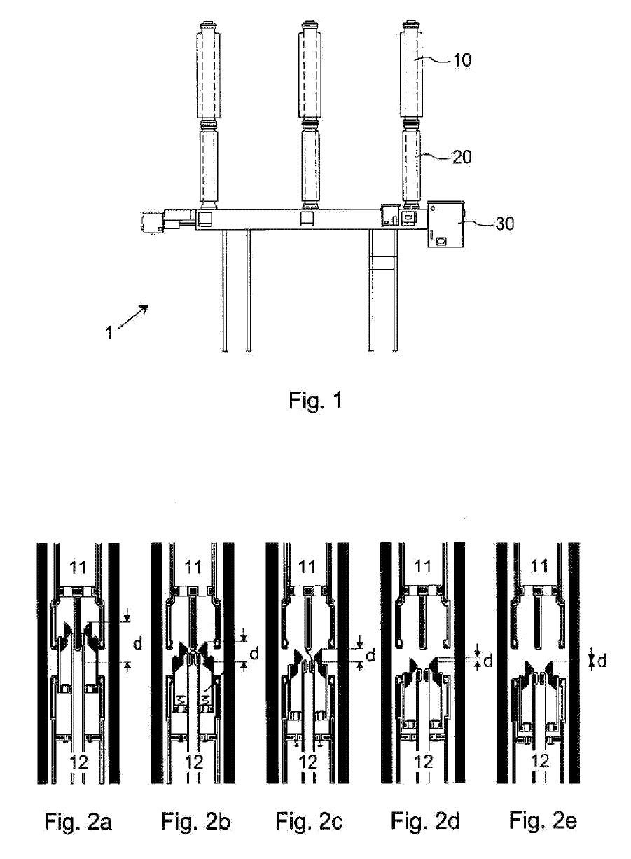

A three-phase high-voltage disconnecting circuit breaker is shown in FIG. 1, that is a combined high-voltage disconnector and high-voltage circuit breaker. A current interrupting chamber 10 provided on a support insulator 20 is provided for each of the phases of the circuit breaker. In each of the current interrupting chambers 10, current interruption is obtained under control of a control unit 30 by separating two contacts in a medium, such as sulfur hexafluoride (SF₆), having excellent dielectric and arc quenching properties. After contact separation, current is carried through an arc and is interrupted when the arc is cooled by a gas blast of sufficient intensity.

The dielectric strength requirements and other requirements on high-voltage disconnecting circuit breakers are specified in the International Standard IEC 62271-108.

The high-voltage disconnecting circuit breaker of the invention and the operation thereof will now be described in detail with reference to FIGS. 2a-e and 3. FIGS. 2a-e show two arcing contacts 11 and 12 in a current interrupting chamber 10 of the high-voltage disconnecting circuit breaker 1. The first contact 11 is fixed while the second contact 12 is movable in an axial direction with relation to the first contact 11.

The movement of the second contact 12 may be accomplished by a spring based actuator and a hydraulically damped piston (not shown) as controlled by the control unit 30 of the high-voltage disconnecting circuit breaker. Alternatively, the piston may be driven by a servo motor or similar. However, any other means of effecting the axial movement are feasible.

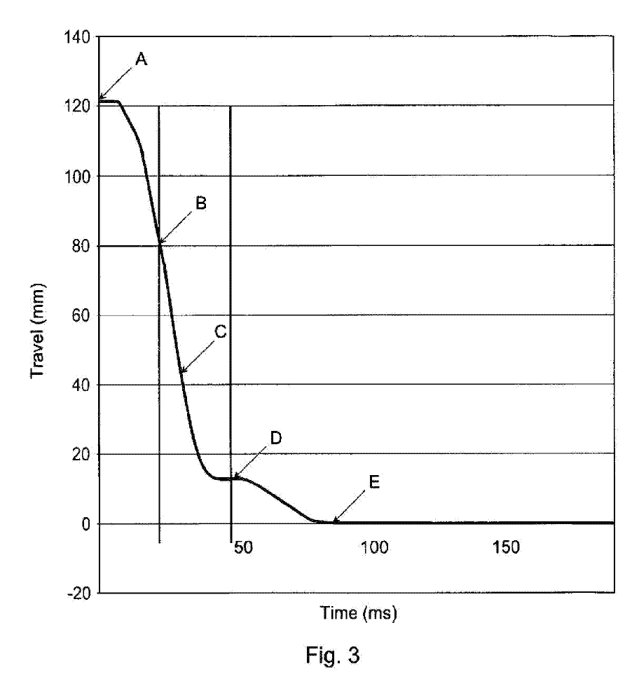

FIG. 2a shows the contacts in closed position, i.e., with current flowing. Breaking is then initiated, corresponding to point “A” in the diagram of FIG. 3. This diagram shows the distance d (in mm) between the current position and the final position of the second contact 12 as a function of time (in ms).

After a small delay, the second contact 12 starts to move out of connection with the first contact 11. The second contact leaves galvanic contact with the first contact after approximately 20 ms, see FIG. 2b, which corresponds to point “B” in FIG. 3. It shall be appreciated that current contacts of the high-voltage circuit breaker have at this point already been moved out of galvanic contact.

The second contact 12 continues to move axially while out of galvanic contact with the first contact, see FIG. 2c, corresponding to point “C” in FIG. 3. As soon as the two contacts 11, 12 are out of galvanic contact with each other, an arc appears due to the high current through the contacts. This arc is cooled and quenched by means of a suitable gas, such as SF₆, which is injected in the space between the two contacts while the second contact 12 continues to move further from the first contact 11. The quenching of the arc has been completed before the second contact has reached the position shown in FIG. 2d, corresponding to point “D” in FIG. 3.

It shall be appreciated that a so-called thermal chamber or a self-blast chamber could be used to provide the injection of the quenching gas.

In order to obtain proper quenching of the arc, the movement rate of the second contact 12 and the distance between the contacts 11, 12 have to be accurately controlled. The quenching period is delimited by the two vertical lines crossing points “B” and “D”, respectively. At the time when the quenching has been completed, the mutual distance of the two contacts, i.e., the smallest distance between the two contacts is approximately 65 mm, corresponding to 100% of nominal contact stroke. Thus, the operation of the high-voltage disconnecting circuit breaker between points “A” and “D” provides the functionality of an ordinary high-voltage circuit breaker.

The example diagram in FIG. 3 illustrates parameters for an ABB high-voltage alternating current circuit breaker having a voltage rating of 145 kV as specified in the International Standard IEC 62271-100 and a rated lightning impulse withstand voltage of 650 kV peak value as specified by the International Standard IEC 62271-1. For a circuit breaker having worn contact surfaces the impulse withstand voltage has to be 80% of 650 kV.

After that the quenching period has been ended, the second contact 12 moves a further approximately 10-15 mm from the first contact until it reaches the final position shown in FIG. 2e, corresponding to point “E” in FIG. 3. By moving the second contact this further distance, i.e., by increasing the contact stroke a further approximately 10% of nominal contact stroke, increased dielectric strength of the high-voltage circuit breaker is obtained without influencing the interrupting performance thereof. This increased dielectric strength is of particular importance as the high-voltage circuit breaker is a high-voltage disconnecting circuit breaker, which, besides functioning as a circuit breaker in a power system, also replaces disconnectors conventionally used in such power systems. The additional operation of the high-voltage disconnecting circuit breaker between points “D” and “E” thus provides the voltage withstand functionality of a high-voltage disconnector.

The example diagram of FIG. 3 illustrates dimension values between points “D” and “E” to obtain dielectric strength requirements as specified for a high-voltage alternating current disconnector having a voltage rating of 145 kV, that is, having a rated lightning impulse withstand voltage of 750 kV according to the standard IEC 62271-1 across the isolating distance. The impulse withstand voltage has to be 750 kV also for a device having worn contacts.

The increased contact stroke can be obtained by controlling the hydraulically damped piston in a suitable way. A linear dashpot, i.e., a damper which resists motion via viscous friction, may be provided to obtain the desired contact stroke characteristics. Optionally, the damping is combined with a suitable, e.g. non-linear, over-toggle mechanism.

It shall be noted that the above disclosed high-voltage disconnecting circuit breaker has a circuit breaking performance which is optimized for the voltage rating of the circuit breaker. That is, the circuit breaking functionality is identical to that of a standard circuit breaker rated for the same voltage. The dielectric strength functionality is obtained by an increased contact stroke. Particularly, it shall be noted that the distance d at point “D”, that is the distance obtained when the quenching period ends, shall not be too long, or otherwise the performance is deteriorated.

The high-voltage disconnecting circuit breaker of the invention is preferably a high-voltage alternating current disconnecting circuit breaker for a rated voltage of 72.5 kV or above and fulfills international as well as national standards and regulations. In particular, the circuit breaker fulfills the International Standard IEC 62271-108.

It shall particularly be noted that the high-voltage alternating current disconnecting circuit breaker is a standard high-voltage current disconnecting circuit breaker having a voltage rating adapted for the voltages occurring, that is having an optimized circuit breaking performance for the voltage rating/the occurring voltages, which has obtained an increased contact stroke length by means of a modified damper, to thereby obtain a voltage withstand capability sufficient for fulfilling the requirements of a disconnecting functionality for the given voltage rating.

According to a further embodiment of the invention a method is provided for modifying a high-voltage circuit breaker of a first voltage rating to obtain a high-voltage disconnecting circuit breaker of the first voltage rating, wherein the high-voltage circuit breaker comprises a first and a second contact, means provided for moving the contacts to a first mutual distance, and means provided for quenching any arc appearing between the contacts during the movement to thereby provide high-voltage circuit breaking. The method comprises the additional step of modifying the means provided for moving so that it is capable of moving the contacts to a second mutual distance larger than the first mutual distance after having moved the contacts to the first mutual distance to thereby provide the dielectric strength functionality of a high-voltage disconnector having the first voltage rating.

The above embodiment may comprise any other of the features disclosed in the present patent.

Embodiments of a high-voltage disconnecting circuit breaker according to the invention have been described. A person skilled in the art realizes that these could be varied within the scope of the appended claims. For instance, although embodiments with one movable and one fixed contact has been described, it will be realized that the inventive idea is applicable also to other kinds of contact configurations, such as one comprising two axially movable contacts. The wording moving the contacts should thus be read as moving the contacts with respect to one another, that is, one or more contacts are moved so as to adjust the mutual distance of the contacts.

Still further, it shall be appreciated that several current interrupting chambers may be arranged in series and operated synchronously to relax the demands on the voltage withstand capability of each of the interrupting chambers.

1. A high-voltage disconnecting circuit breaker comprising:
a first and a second contact; and
means provided for moving the contacts to a first mutual distance and means provided for quenching any arc appearing between the contacts during said movement to thereby provide the functionality of a high-voltage circuit breaker, characterised in that
said means provided for moving is further provided for moving the contacts to a second mutual distance larger than the first mutual distance after quenching of any arc to thereby provide the dielectric strength functionality of a high-voltage disconnector.

2. The disconnecting circuit breaker according to claim 1, wherein said means provided for moving comprises a damper based on a hydraulic piston.

3. The disconnecting circuit breaker according to claim 2, wherein said means provided for moving is provided for moving the contacts to the first and second mutual distances in an axial direction with respect to the contacts in a single stroke.

4. The disconnecting circuit breaker according to claim 1, wherein said means provided for quenching comprises a sulfur hexafluoride gas.

5. The disconnecting circuit breaker according to claim 1, wherein the contact moving means is provided for moving the contacts to the first mutual distance at a first rate and for moving the contacts from the first mutual distance to the second mutual distance at a second rate, said first rate being higher than said second rate.

6. The disconnecting circuit breaker according to claim 1, wherein the second mutual distance is at least 5% larger than the first mutual distance.

7. The disconnecting circuit breaker according to claim 1, wherein said arc quenching means is provided for quenching any arc appearing between the contacts during a quenching period, the end of which occurs when the contacts have been moved to the first mutual distance.

8. The disconnecting circuit breaker according to claim 1, wherein said disconnecting circuit breaker has a given voltage rating and wherein said disconnecting circuit breaker has, when the contacts are moved to the first mutual distance, a withstand voltage as specified by international or national regulations for a circuit breaker having said given voltage rating, and said disconnecting circuit breaker has, when the contacts are moved to the second mutual distance, a withstand voltage as specified by international or national regulations for a disconnector having said given voltage rating.

9. The disconnecting circuit breaker according to claim 8, wherein said international or national regulations are those specified by the International Standard IEC.

10. The disconnecting circuit breaker according to claim 1, wherein the disconnecting circuit breaker has a given voltage rating and wherein said circuit breaking functionality and said dielectric strength functionality are optimized for said given voltage rating.

11. The disconnecting circuit breaker according to claim 1, wherein said high-voltage disconnecting circuit breaker has a rated voltage of 72.5 kV or higher.

12. A method of operating a high-voltage disconnecting circuit breaker comprising a first and a second contact, the method comprising the following steps:
moving the contacts to a first mutual distance and quenching any arc appearing between the contacts to thereby provide the functionality of a high-voltage circuit breaker, characterised by the additional step of:
moving the contacts to a second mutual distance larger than the first mutual distance after quenching of any arc to thereby provide the dielectric strength functionality of a high-voltage disconnector.

13. The method according to claim 12, wherein the contacts are moved to the first and second mutual distances by a movement device including a controlled hydraulic piston.

14. The method according to claim 12, wherein the second mutual distance is at least 5% larger than the first mutual distance.

15. The method according to claim 12, wherein quenching is performed during a quenching period, the end of which occurs when the contacts have been moved to the first mutual distance.

16. The method according to claim 12, wherein at least part of the movement to the second mutual distance is affected by means of a non-linear over-toggle mechanism.

17. The method according to claim 12, wherein at least part of the movement to the second mutual distance is effected by means of a non-linear dashpot.

18. The method according to claim 12, wherein the disconnecting circuit breaker has a given voltage rating and wherein said circuit breaking functionality and said dielectric strength functionality are optimized for said given voltage rating.

19. A method for modifying a high-voltage circuit breaker of a first voltage rating to obtain a high-voltage disconnecting circuit breaker of the first voltage rating, wherein the high-voltage circuit breaker comprises a first and a second contact, means provided for moving the contacts to a first mutual distance, and means provided for quenching any arc appearing between the contacts during said movement to thereby
provide high-voltage circuit breaking, said method being characterised by the additional step of:
modifying said means provided for moving so that it is capable of moving the contacts to a second mutual distance larger than the first mutual distance after having moved the contacts to the first mutual distance to thereby provide the dielectric strength functionality of a high-voltage disconnector having the first voltage rating.

20. The disconnecting circuit breaker according to claim 1, wherein the second mutual distance is at least 10% larger than the first mutual distance.

21. The disconnecting circuit breaker according to claim 1, wherein the second mutual distance is between about 10% and 25% larger than the first mutual distance.

22. The method according to claim 12, wherein the second mutual distance is at least 10% larger than the first mutual distance.

23. The method according to claim 12, wherein the second mutual distance is between about 10% and 25% larger than the first mutual distance.
